(19) United States
(12) Patent Application Publication
(10) Pub. No.: US 2020/0314252 A1
(43) Pub. Date: Oct. 1, 2020

(54) IMAGE POSITION SETTING APPARATUS CAPABLE OF EASILY SETTING IMAGE POSITION ADJUSTMENT VALUE, METHOD OF CONTROLLING SAME, AND STORAGE MEDIUM

(71) Applicant: CANON KABUSHIKI KAISHA, Tokyo (JP)

(72) Inventors: Yusuke Kimura, Kokubunji-shi (JP); Nobuhiro Kawamura, Nagareyama-shi (JP); Hiroya Igarashi, Toride-shi (JP)

(21) Appl. No.: 16/819,593

(22) Filed: Mar. 16, 2020

(30) Foreign Application Priority Data
Mar. 29, 2019 (JP) 2019-067706

(51) Int. Cl. H04N 1/00

(52) U.S. Cl. CPC H04N 1/0044; H04N 1/00702; H04N 1/00411

(57) ABSTRACT

An image position setting apparatus which enables a user to easily grasp whether or not image position adjustment values can be adjusted to desired values. The image position setting apparatus sets the image position adjustment values for adjusting image forming positions on a sheet. At least one memory stores a set of instructions. At least one processor executes the instructions. When the instructions are executed, the image position adjustment values are set, and display of an input screen for inputting the image position adjustment values is controlled. In the display control, allowable adjustment ranges of the image position adjustment values are displayed on the input screen with increase/decrease amounts relative to currently set image position adjustment values.

### BACKGROUND OF THE INVENTION

### Field of the Invention

The present invention relates to an image position setting apparatus that is capable of easily setting an image position adjustment value, a method of controlling the same, and a storage medium.

### Description of the Related Art

There has been known an image position setting apparatus that sets image position adjustment values for adjusting a position on a sheet where an image forming apparatus forms an image (hereinafter referred to as the “image position”). The image position setting apparatus is e.g. a communication apparatus, such as a client PC or a print control apparatus, which performs data communication with the above-mentioned image forming apparatus. The communication apparatus accesses the image forming apparatus using an application installed thereon, to thereby remotely set image position adjustment values for the image forming apparatus. A user grasps the displacement of the image position based on results of printing a specific part of a test page by the image forming apparatus, and inputs adjustment values for correcting the displacement to a setting screen displayed on the communication apparatus. In the image forming apparatus, values obtained by accumulation (addition or subtraction) of the values input to the setting screen to or from the image position adjustment values set in the past are set as the updated image position adjustment values, and the image position is adjusted based on the updated image position adjustment values. In a case where the updated image position adjustment values exceed allowable adjustment ranges defined by predetermined upper limit values and lower limit values, a notification indicative of the excess of the allowable adjustment ranges is transmitted. This makes it possible for the user to grasp whether or not the image position adjustment values can be adjusted to desired values. The allowable adjustment ranges are determined based on e.g. the movable ranges of print heads of all colors in an inkjet printer as the image forming apparatus (see e.g. Japanese Laid-Open Patent Publication (Kokai) No. 2010-5822).

Conventionally, however, until the user inputs values for correcting the displacement to the setting screen and further instructs to set image position adjustment values obtained by accumulation of the input values, for the image forming apparatus, it is not determined whether or not the image position adjustment values exceed the allowable adjustment ranges. For this reason, when inputting the values to the setting screen, the user cannot grasp whether or not the image position adjustment values can be adjusted to the desired values.

### SUMMARY OF THE INVENTION

The present invention provides an image position setting apparatus which enables a user to easily grasp whether or not an image position adjustment value can be adjusted to a desired value, a method of controlling the same, and a storage medium.

In a first aspect of the present invention, there is provided an image position setting apparatus that sets an image position adjustment value for adjusting a position on a sheet where an image is formed, comprising at least one memory that stores a set of instructions; and at least one processor that executes the instructions, the instructions, when executed, causing the image position setting apparatus to perform operations comprising setting the image position adjustment value, and performing display control of an input screen for inputting the image position adjustment value, wherein the display control includes displaying an allowable adjustment range of the image position adjustment value on the input screen, using increasing and decreasing amounts relative to a currently set image position adjustment value.

In a second aspect of the present invention, there is provided a method of controlling an image position setting apparatus that sets an image position adjustment value for adjusting a position on a sheet where an image is formed, comprising setting the image position adjustment value, and performing display control of an input screen for inputting the image position adjustment value, wherein the display control includes displaying an allowable adjustment range of the image position adjustment value on the input screen using increasing and decreasing amounts relative to a currently set image position adjustment value.

In a third aspect of the present invention, there is provided a non-transitory computer-readable storage medium storing a computer-executable program for executing a method of controlling an image position setting apparatus that sets an image position adjustment value for adjusting a position on a sheet where an image is formed, wherein the method comprises setting the image position adjustment value, and performing display control of an input screen for inputting the image position adjustment value, wherein the display control includes displaying an allowable adjustment range of the image position adjustment value on the input screen using increasing and decreasing amounts relative to a currently set image position adjustment value.

According to the present invention, it is possible for a user to easily grasp whether or not an image position adjustment value can be adjusted to a desired value.

Further features of the present invention will become apparent from the following description of exemplary embodiments (with reference to the attached drawings).

### BRIEF DESCRIPTION OF THE DRAWINGS

FIG. 1 is a schematic diagram of a sheet management system which includes a print control apparatus as an image position setting apparatus according to an embodiment of the present invention.

FIGS. 2A and 2B are schematic block diagrams showing a hardware configuration and a software configuration of an image forming apparatus appearing in FIG. 1, respectively.

FIGS. 3A and 3B are schematic block diagrams showing a hardware configuration and a software configuration of the print control apparatus appearing in FIG. 1, respectively.

FIGS. 4A and 4B are diagrams showing examples of a table managed by the print control apparatus.

FIG. 5 is a diagram showing a top screen for performing sheet management of the sheet management system.

FIG. 6 is a diagram showing an example of a setting screen displayed on the print control apparatus.

FIGS. 7A and 7B are diagrams showing examples of screens displayed on the print control apparatus.

FIG. 8 is a sequence diagram useful in explaining an adjustment values-setting process performed by the sheet management system.

FIGS. 9A and 9B are flowcharts of processes associated with setting adjustment values, which is performed by the print control apparatus.

FIG. 10 is a diagram showing an example of a screen displayed on the print control apparatus.

### DESCRIPTION OF THE EMBODIMENTS

The present invention will now be described in detail below with reference to the accompanying drawings showing embodiments thereof.

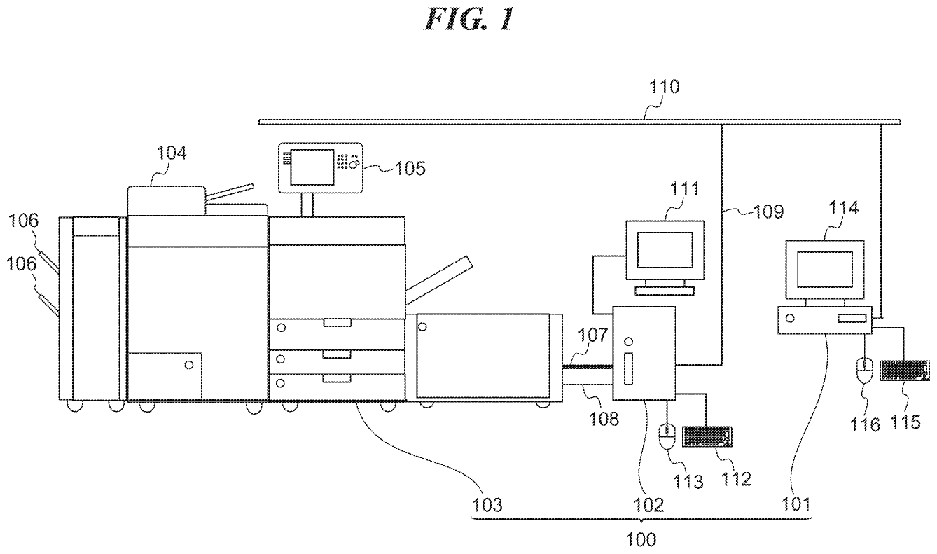

FIG. 1 is a schematic diagram of a sheet management system 100 which includes a print control apparatus 102 as an image position setting apparatus according to an embodiment of the present invention. Referring to FIG. 1, the sheet management system 100 is comprised of a client PC 101, the print control apparatus 102, and an image forming apparatus 103. The print control apparatus 102 is connected to a LAN (Local Area Network) 110 via a LAN cable 109. The print control apparatus 102 performs data communication with the client PC 101 via the LAN 110. Further, the print control apparatus 102 is connected to the image forming apparatus 103 via an image video cable 107 and a control cable 108. The image forming apparatus 103 is not directly connected to the LAN 110 and performs data communication with the client PC 101 via the print control apparatus 102. Note that the above-described configuration is not limitative, but the present embodiment may be configured such that the image forming apparatus 103 is directly connected to the LAN 110, for directly performing data communication with the client PC 101.

The client PC 101 is a communication apparatus that performs data communication with the print control apparatus 102 etc. Connected to the client PC 101 are a display device 114 implemented e.g. by a liquid crystal monitor, a keyboard 115, and a pointing device 116. Further, installed in the client PC 101 are a control application for controlling the sheet management system 100 and a printer driver. The client PC 101 starts the control application to thereby operate the sheet management system 100, and also issues a print instruction using the printer driver.

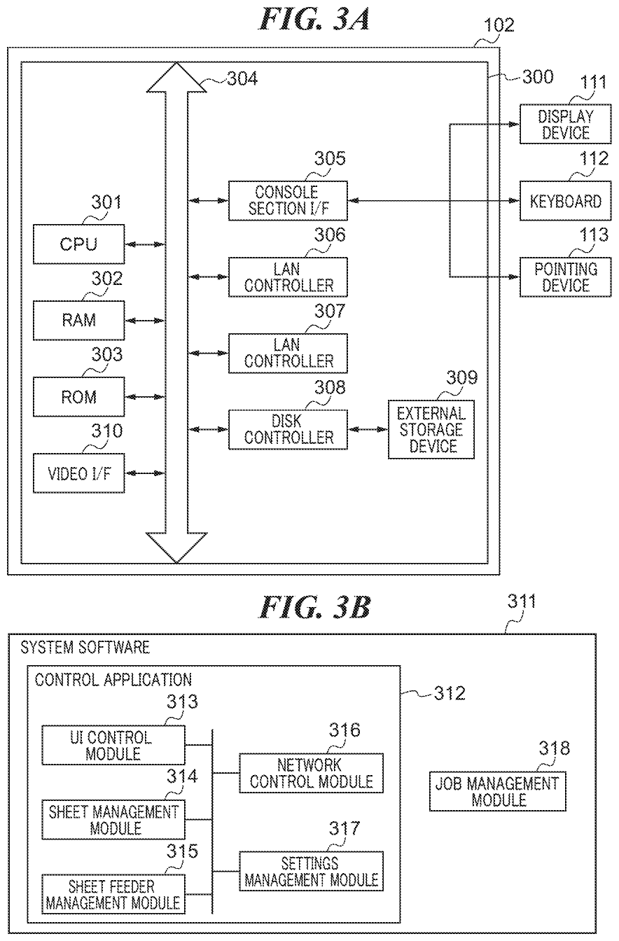

The print control apparatus 102 is a communication apparatus that performs data communication with the client PC 101 and the image forming apparatus 103. A display device 111 implemented e.g. by a liquid crystal monitor, a keyboard 112, and a pointing device 113 are connected to the print control apparatus 102. Note that in the present embodiment, the display device 111 and the display device 114 each may be configured to have a position input function similar to that of a touch pad and thereby also serve as the pointing device. A control application 312, described hereinafter with reference to FIG. 3B, for controlling the sheet management system 100 is installed on the print control apparatus 102. The print control apparatus 102 starts the control application 312 to thereby operate the sheet management system 100, and also performs image processing in cooperation with the image forming apparatus 103.

The image forming apparatus 103 is a multifunction peripheral having a plurality of functions, such as a copy function, a scan function, and a print function. The image forming apparatus 103 includes a scanner 104, a console section 105, a sheet discharge section 106. The image forming apparatus 103 performs image processing based on instructions received from the client computer 101 and the print control apparatus 102. Further, the image forming apparatus 103 performs scan processing using the scanner 104 based on instructions received from a user via various keys of the console section 105. The image forming apparatus 103 copies data read by the scanner 104 or transmits the data to a shared folder. The console section 105 is comprised of a touch-panel type display section and a plurality of keys. The display section displays various information including scan status information. Sheets on which images are printed are discharged onto the sheet discharge section 106. Although in the present embodiment, a description is given of a configuration in which the client computer 101, the print control apparatus 102, and the image forming apparatus 103 are separate from each other, the present invention is not limited to this. For example, the image forming apparatus 103 may have the functions of the client computer 101 and the print control apparatus 102 so as to control processes described hereinafter.

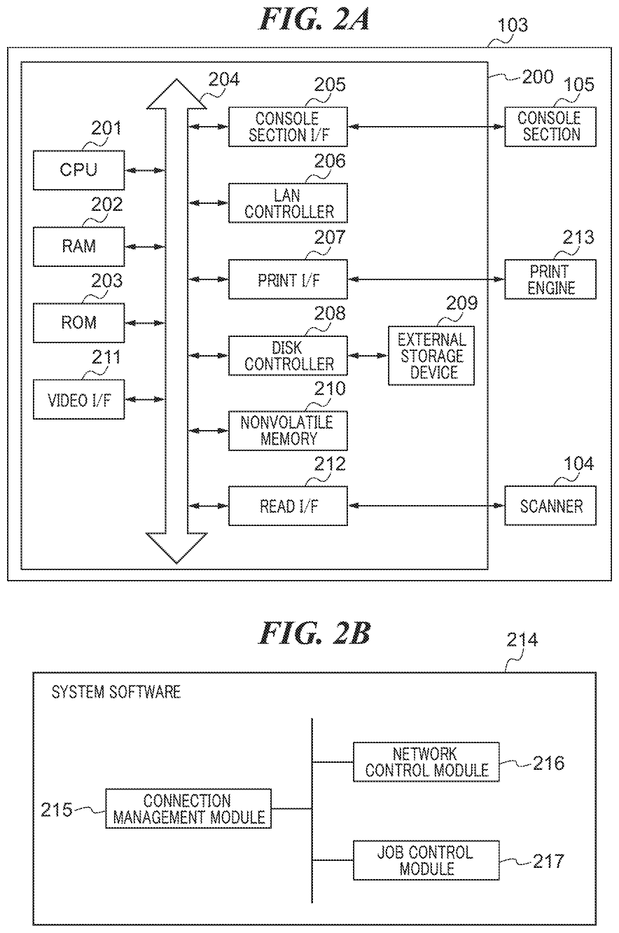

FIGS. 2A and 2B are schematic block diagrams showing configurations of the image forming apparatus 103 in FIG. 1, respectively. FIG. 2A shows a hardware configuration of the image forming apparatus 103. FIG. 2B shows a configuration of system software 214 of the image forming apparatus 103.

Referring to FIG. 2A, the image forming apparatus 103 includes a controller 200 and a print engine 213 in addition to the scanner 104 and the console section 105. The controller 200 is connected to the scanner 104, the console section 105, and the print engine 213. The controller 200 is comprised of a CPU 201, a RAM 202, a ROM 203, a console section interface 205, a LAN controller 206, a print interface 207, a disk controller 208, an external storage device 209, a nonvolatile memory 210, a video interface 211, and a read interface 212. The CPU 201, the RAM 202, the ROM 203, the console section interface 205, the LAN controller 206, the print interface 207, the disk controller 208, the nonvolatile memory 210, the video interface 211, and the read interface 212 are connected to each other via a system bus 204. The external storage device 209 is connected to the disk controller 208.

The controller 200 controls the overall operation of the image forming apparatus 103. The CPU 201 performs centralized control of accesses to and from the devices connected to the system bus 204, based on control programs stored in the ROM 203 or the external storage device 209. For example, the CPU 201 delivers image signals as output information to the print engine 213 connected thereto via the print interface 207, and also obtains image signals from the scanner 104 connected thereto via the read interface 212. The RAM 202 serves as a main memory for the CPU 201 and is used e.g. as a work area for the CPU 201. The ROM 203 stores programs, setting data, and so forth. The console section interface 205 is an interface for connecting the console section 105 to the controller 200. The console section interface 205 receives information input by the user from the console section 105 and transmits a screen display control signal to the console section 105 based on the received information. The LAN controller 206 controls communication with the print control apparatus 102. The print interface 207 is an interface for connecting the print engine 213 to the controller 200. The print engine 213 prints an image on a sheet based on an image signal acquired from the print interface 207. The disk controller 208 controls access to the external storage device 209. The external storage device 209 is e.g. an HDD. The external storage device 209 stores application programs, font data, form data, etc. Further, the external storage device 209 is used as a job storage area for temporarily spooling print job data. Furthermore, the external storage device 209 stores image data read from the scanner 104 and image data of a print job as reserved print data. The nonvolatile memory 210 stores setting information and the like set e.g. from the console section 105 or the print control apparatus 102. The video interface 211 receives image data from the print control apparatus 102.

Referring to FIG. 2B, the system software 214 includes a connection management module 215, a network control module 216, and a job control module 217. Processing operations of the system software 214 are performed by the CPU 201 executing corresponding programs which are stored e.g. in the external storage device 209.

The connection management module 215 controls connection management between control applications installed in the client PC 101 and the print control apparatus 102, and the image forming apparatus 103. For example, the connection management module 215 manages the number of control applications connected to the image forming apparatus 103. The network control module 216 controls data communication with the print control apparatus 102 via the LAN controller 206. The job control module 217 controls a printing sequence, the order of execution of jobs, and so forth.

FIGS. 3A and 3B are schematic block diagrams showing configurations of the print control apparatus 102 in FIG. 1, respectively. FIG. 3A shows a hardware configuration of the print control apparatus 102 and FIG. 3B shows a configuration of system software 311 of the print control apparatus 102.

Referring to FIG. 3A, the print control apparatus 102 includes a controller 300. The controller 300 is comprised of a CPU 301, a RAM 302, a ROM 303, a console section interface 305, a LAN controller 306, a LAN controller 307, a disk controller 308, an external storage device 309, and a video interface 310. The CPU 301, the RAM 302, the ROM 303, the console section interface 305, the LAN controller 306, the LAN controller 307, the disk controller 308, and the video interface 310 are connected to each other via a system bus 304. The external storage device 309 is connected to the disk controller 308.

The CPU 301 performs centralized control of accesses to and from the devices connected to the system bus 304 based on control programs stored in the ROM 303 or the external storage device 309. The RAM 302 serves as a main memory for the CPU 301 and is used e.g. as a work area for the CPU 301. The ROM 303 stores programs, setting data, and so forth. The console section interface 305 is an interface for connecting the display device 111, the keyboard 112, and the pointing device 113 to the controller 300. The console section interface 305 receives information input by the user from the keyboard 112 or the pointing device 113, and transmits a screen display control signal to the display device 111 based on the received information.

The LAN controller 306 controls communication with the image forming apparatus 103. The LAN controller 307 controls communication with a device that forms the LAN 110, e.g. the client PC 101. The disk controller 308 controls access to the external storage device 309. The external storage device 309 is e.g. an HDD. The external storage device 309 stores application programs, font data, form data, etc., and further temporarily spools print job data. The spooled job data is processed by a RIP (Raster Image Processor). Furthermore, the external storage device 309 is used as a job data storage area for storing the job data having been processed by the RIP. The video interface 310 transmits the job data having been processed by the RIP to the image forming apparatus 103.

Referring to FIG. 3B, the system software 311 includes the control application 312 and a job management module 318. The control application 312 is comprised of a UI control module 313, a sheet management module 314, a sheet feeder management module 315, a network control module 316, and a settings management module 317. Processing operations of the system software 311 are performed by the CPU 301 executing corresponding programs which are stored in the external storage device 309 or the like.

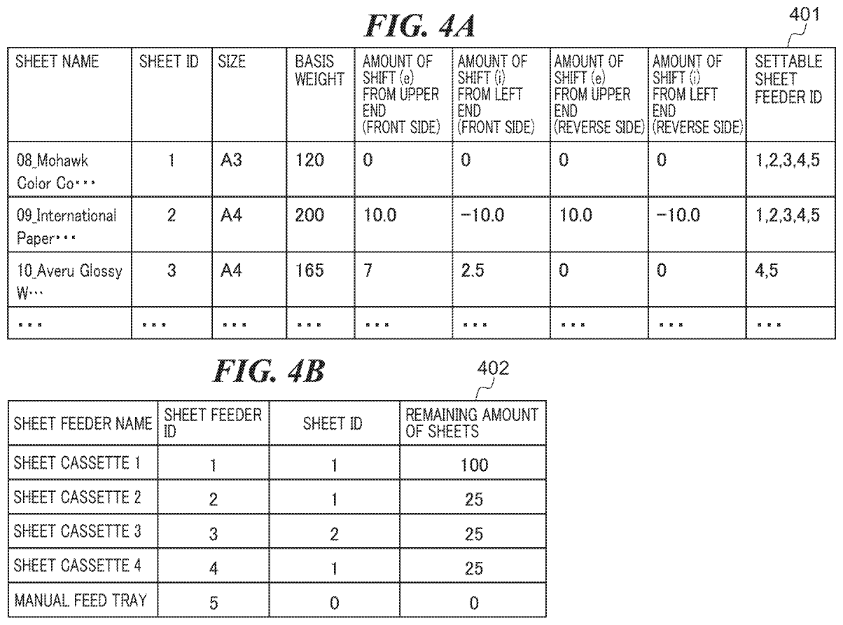

The control application 312 is a module for operating the sheet management system 100 from the print control apparatus 102. The UI control module 313 performs control for displaying a screen concerning the sheet management system 100 on the display device 111. For example, the UI control module 313 switches a screen display language and a unit system of sheet sizes for display, which are displayed on the display device 111, according to the configuration of the system. The sheet management module 314 manages sheet information acquired from the image forming apparatus 103 by a sheet setting management table 401 in FIG. 4A. The sheet information includes e.g. the sizes and basis weight of sheets that can be used in printing by the image forming apparatus 103 and the adjustment values for the image position for printing. The sheet management module 314 performs editing, addition, deletion, search of sheet information in the sheet setting management table 401. In the sheet setting management table 401, the sheet information is managed on a unique sheet ID basis. The sheet setting management table 401 is stored in the external storage device 309.

The sheet feeder management module 315 manages sheet feeder information acquired from the image forming apparatus 103 using a sheet feeder management table 402 in FIG. 4B. The sheet feeder management module 315 performs editing, addition, deletion, and search of sheet feeder information in the sheet feeder management table 402. The sheet feeder information includes e.g. information on sheet feeders provided in the image forming apparatus 103, information indicative of the remaining amounts of sheets stored in the respective sheet feeders of the image forming apparatus 103. In the sheet feeder management table 402, the sheet feeder information is managed using unique sheet feeder IDs assigned to the sheet feeders, respectively. The sheet feeder management table 402 is stored in the external storage device 309.

The network control module 316 controls communication by the LAN controller 306 and the LAN controller 307. For example, when an instruction for operating the sheet management system 100 is received from the client PC 101 via the LAN controller 307, the network control module 316 transmits and receives data associated with the instruction to and from the image forming apparatus 103 via the LAN controller 306. The settings management module 317 manages the system settings of the sheet management system 100. Examples of the system settings of the sheet management system 100 include a setting indicative of the screen display language of the sheet management system 100, and a setting of the unit system of sheet sizes for display (mm or inch). The system settings of the sheet management system 100 are stored in the external storage device 309.

The job management module 318 manages the printing sequence and the order of execution of jobs. The job management module 318 manages PDL data received by the print control apparatus 102 as job data. The job management module 318 performs RIP processing on the PDL data to thereby generate raster image data which can be read by the image forming apparatus 103. Further, the job management module 318 analyzes a print instruction included in the PDL data to thereby create print setting information used for printing. The job management module 318 transfers image data and the print setting information to the image forming apparatus 103 via the LAN controller 306 and the video interface 310.

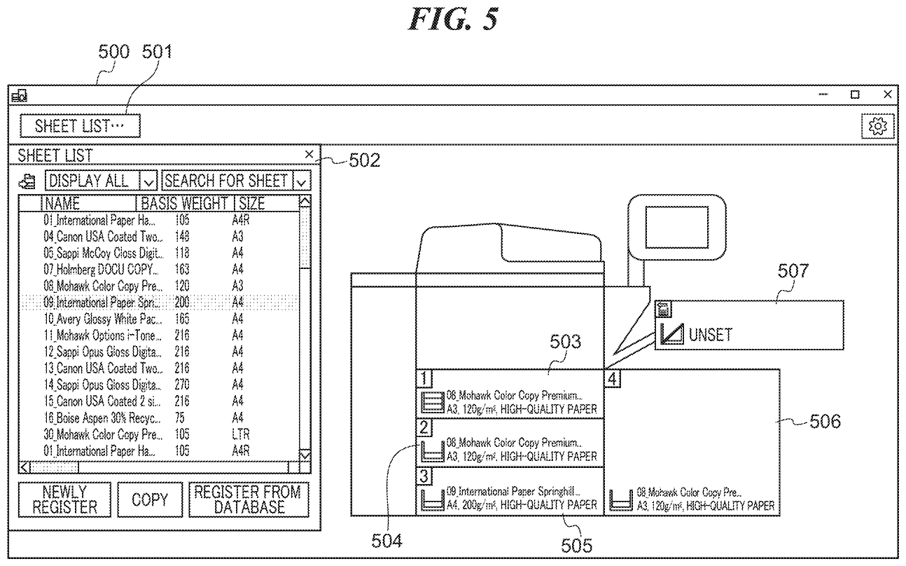

FIG. 5 shows a top screen 500 for performing sheet management of the sheet management system 100 in FIG. 1. The top screen 500 is displayed on the display device 111 of the print control apparatus 102 e.g. when the control application 312 is started. Note that although in the present embodiment, the description is given of a case where the top screen 500 is displayed on the display device 111 of the print control apparatus 102, by way of example, the top screen 500 may be displayed on the display device 114 of the client PC 101 or the console section 105 of the image forming apparatus 103.

On the top screen 500, there is displayed information concerning the sheet feeders of the image forming apparatus 103 connected to the print control apparatus 102. A sheet list button 501 on the top screen 500 is a button for instructing display of a sheet list screen 502. The sheet list screen 502 includes a list of sheet information items. On the sheet list screen 502, it is possible to perform e.g. an operation for registering a selected sheet information item in a designated sheet feeder.

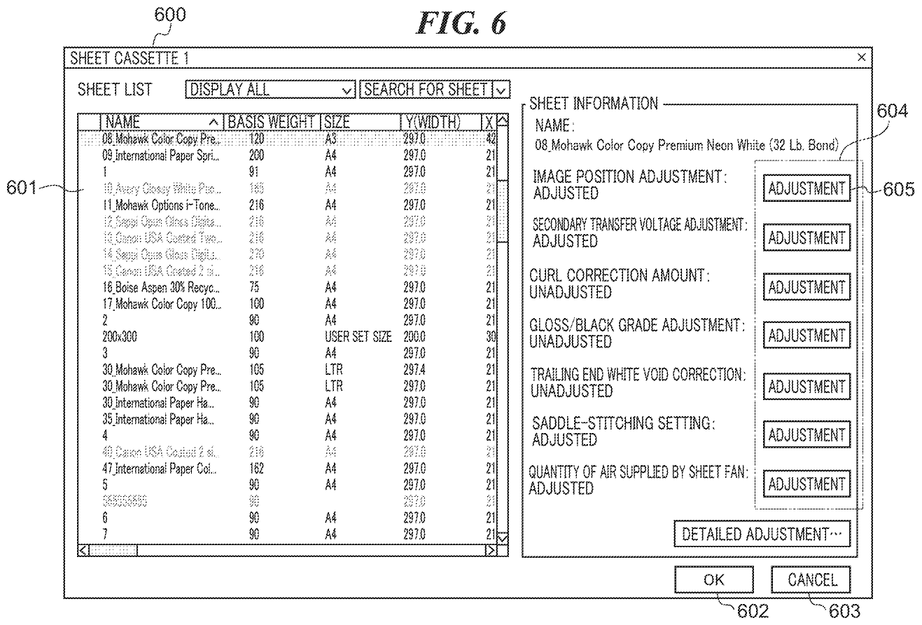

Sheet feeder buttons 503 to 507 are operation buttons associated with the sheet feeders of the image forming apparatus 103, respectively, and are provided for calling information on sheets stored in the sheet feeders. The sheet feeder buttons 503 to 507 are created based on sheet feeder information which the print control apparatus 102 acquires from the image forming apparatus 103 when the sheet management system 100 is activated. When a sheet feeder status change event is received from the image forming apparatus 103, the controller 300 of the print control apparatus 102 acquires the sheet feeder information from the image forming apparatus 103 again. When the user selects e.g. the sheet feeder button 503 associated with a sheet cassette 1 (not shown) of the image forming apparatus 103 on the top screen 500, the display on the display device 111 switches from the top screen 500 to a setting screen 600 in FIG. 6.

The setting screen 600 is a screen for setting sheet information of the sheet cassette 1 associated with the sheet feeder button 503. The setting screen 600 includes a sheet list display area 601, an OK button 602, and a cancel button 603. In the sheet list display area 601, the sheet information set for the sheet cassette 1 is displayed in a selected state. When the user presses the OK button 602 in the state where the sheet information is selected in the sheet list display area 601, the controller 300 configures sheet settings for the image forming apparatus 103 based on the selected sheet information, and closes the setting screen 600. On the other hand, when the user presses the cancel button 603 in the state where the sheet information is selected in the sheet list display area 601, the controller 300 closes the setting screen 600 without configuring sheet settings for the image forming apparatus 103.

Further, the setting screen 600 includes an adjustment screen call button group 604. In the present embodiment, to improve user convenience, the setting screen 600 displays adjustment screen call buttons for calling adjustment screens on which, out of a plurality of adjustment items concerning sheet settings of the image forming apparatus 103, adjustment items frequently used by the user are set. For example, the setting screen 600 displays adjustment screen call buttons for calling adjustment screens for image position adjustment, secondary transfer voltage adjustment, curl correction amount, gloss/black grade adjustment, trailing end white void correction, saddle-stitching setting, and the quantity of air supplied by a sheet fan. Here, an item of image position adjustment is an adjustment item for adjusting the image position on the front and reverse sides of a sheet. According to the present embodiment, in the image position adjustment, adjustment values for the image position from the upper end and left end of each of the front and reverse sides of a sheet are set as amounts of shift. The setting screen 600 displays a currently selected sheet name, and information indicating whether or not the adjustment value of each adjustment item is changed from its initial value set for the image forming apparatus 103. For an adjustment item whose adjustment value is not changed from its initial value, “unadjusted”, which indicates that the adjustment value thereof is not changed from its initial value, is displayed, whereas for an adjustment item whose adjustment value is changed from its initial value, “adjusted”, which indicates that the adjustment value thereof is changed from its initial value, is displayed.

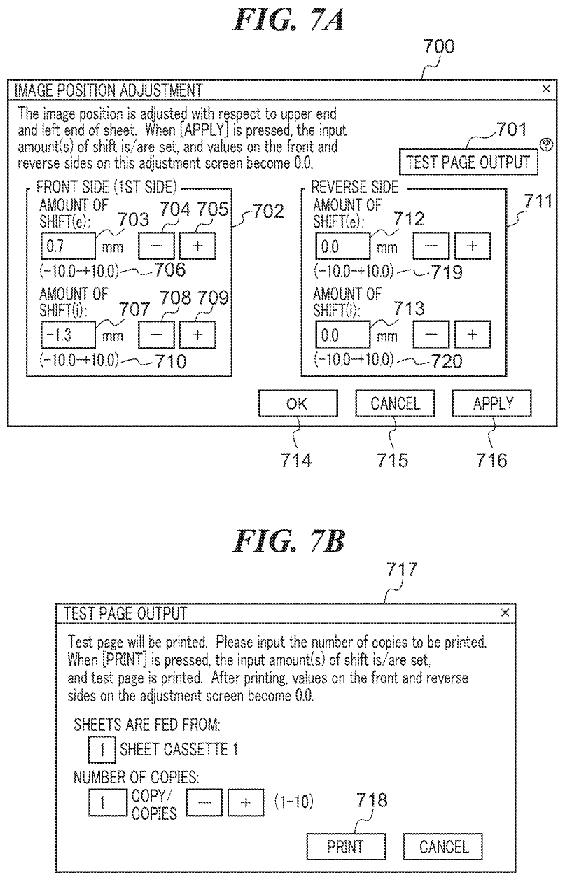

When the user selects an image position adjustment screen call button 605 from the adjustment screen call button group 604 on the setting screen 600, the display on the display device 111 switches from the setting screen 600 to an image position adjustment screen 700 (input screen) shown in FIG. 7A. The image position adjustment screen 700 is for setting the adjustment values for the image position on the front and reverse sides of the sheet.

The image position adjustment screen 700 includes a test page output button 701, a front side shift amount-setting area 702, a reverse side shift amount-setting area 711, an OK button 714, a cancel button 715, and an apply button 716. The test page output button 701 is for giving an instruction for switching the display on the display device 111 from the image position adjustment screen 700 to a test page output screen 717 shown in in FIG. 7B. When the user selects a print button 718 on the test page output screen 717, the controller 300 transmits to the image forming apparatus 103 a print instruction for printing a test page with the mage position adjusted by adjustment values set on the image position adjustment screen 700. Upon receipt of this print instruction, the image forming apparatus 103 prints the test page with the image position adjusted by the adjustment values. The user grasps a displacement of the image position based on results of printing a specific part of the output test page and inputs adjustment values for correcting the displacement to the image position adjustment screen 700, whereby it is possible to adjust the image position. The input adjustment values are accumulated (added to or subtracted from) the amounts of shift in the sheet setting management table 401. In the present embodiment, the image position is adjusted based on values obtained by accumulation of values input to the image position adjustment screen 700 to adjustment values for the image position set in the past.

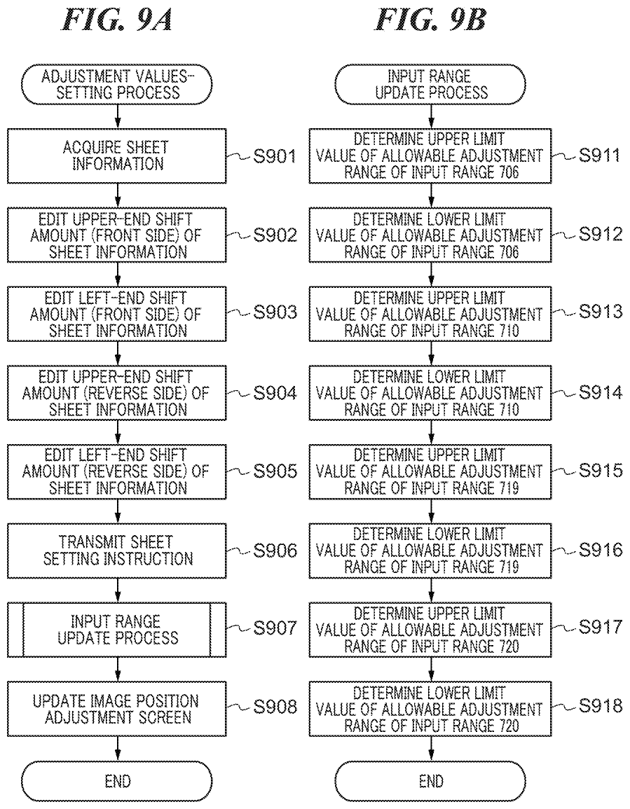

The front side shift amount-setting area 702 includes an upper-end shift amount-inputting field 703 and a left-end shift amount-inputting field 707. An adjustment value (amount of shift) from the upper end of the front side of the test page is input to the upper-end shift amount-inputting field 703. The user directly inputs the adjustment value using the keyboard 112 or alternatively inputs the adjustment value by selecting a −button 704 or a +button 705. When the user selects the −button 704 once, a value in the upper-end shift amount-inputting field 703 is subtracted by 0.1. On the other hand, when the user selects the +button 705 once, 0.1 is added to the value in the upper-end shift amount-inputting field 703. An input range 706 displays an allowable adjustment range of the adjustment value from the upper end of the front side. The allowable adjustment range is defined by an upper limit value and a lower limit value determined by an input range update process described hereinafter with reference to FIG. 9B.

An adjustment value (amount of shift) from the left end of the front side of the test page is input to the left-end shift amount-inputting field 707. The user directly inputs the adjustment value using the keyboard 112 or alternatively inputs the adjustment value by selecting a −button 708 or a +button 709. An input range 710 displays an allowable adjustment range of the adjustment value from the left end of the front side.

The reverse side shift amount-setting area 711 has the same configuration as that of the front side shift amount-setting area 702. An adjustment value (amount of shift) from the upper end of the reverse side of the test page is input to an upper-end shift amount-inputting field 712 of the reverse side shift amount-setting area 711. An allowable adjustment range of the adjustment value from the upper end of the reverse side is displayed in an input range 719. An adjustment value (amount of shift) from the left end of the reverse side of the test page is input to a left-end shift amount-inputting field 713 of the reverse side shift amount-setting area 711. An allowable adjustment range of the adjustment value from the left end of the reverse side is displayed in an input range 720. The OK button 714 is for setting sheet settings for the image forming apparatus 103, using the adjustment values input to the image position adjustment screen 700, and then closing the image position adjustment screen 700. The cancel button 715 is for closing the image position adjustment screen 700 without setting sheet settings for the image forming apparatus 103. The apply button 716 is for setting sheet settings for the image forming apparatus 103, using the adjustment values input to the image position adjustment screen 700 without closing the image position adjustment screen 700. In the present embodiment, the controller 300 controls the apply button 716 such that the apply button 716 can be selected only when a difference has occurred from the current settings. Further, after completion of setting the sheet settings, the controller 300 resets each of the values in the upper-end shift amount-inputting field 703, the left-end shift amount-inputting field 707, the upper-end shift amount-inputting field 712, and the left-end shift amount-inputting field 713 to 0, which is an initial value thereof. This makes it possible to save time and effort for deleting the values in the input fields, for a user continues to output a test page for readjustment.

Next, a description will be given how adjustment values for the image forming apparatus 103 are set by the sheet management system 100. In the following description, setting processing in which the user sets the adjustment values for the image forming apparatus 103 from the print control apparatus 102 activated by the control application 312 will be described by way of example. The setting processing for setting the adjustment values for the image forming apparatus 103 from the print control apparatus 102 is performed by the CPU 301 of the print control apparatus 102 executing corresponding programs which are stored in the external storage device 309. In the present embodiment, it is assumed that the user sets adjustment values for the image position for the image forming apparatus 103 as an example of the adjustment values for the image forming apparatus 103. When the control application 312 is activated, the controller 300 of the print control apparatus 102 performs communication with the image forming apparatus 103 and thereby acquires sheet feeder information from the image forming apparatus 103. The sheet feeder information acquired at this time includes information indicating e.g. names of sheet feeders provided in the image forming apparatus 103, sheet feeder IDs uniquely assigned to the respective sheet feeders, and the remaining amounts of sheets stored in the respective sheet feeders. The controller 300 controls the sheet feeder management module 315 to write the acquired information in the sheet feeder management table 402. Further, the controller 300 acquires sheet information from the image forming apparatus 103. The sheet information acquired at this time includes e.g. names indicative of the types of sheets printable by the image forming apparatus 103, parameters required for printing, and sheet feeder IDs of sheet feeders that can be set in the image forming apparatus 103. The parameters required for printing include a basis weight and the size of sheets, and the adjustment values of the respective adjustment items including image position adjustment. The controller 300 controls the sheet management module 314 to write the acquired sheet information in the sheet setting management table 401. Then, the controller 300 displays the top screen 500 on the display device 111 based on the acquired sheet feeder information and sheet information.

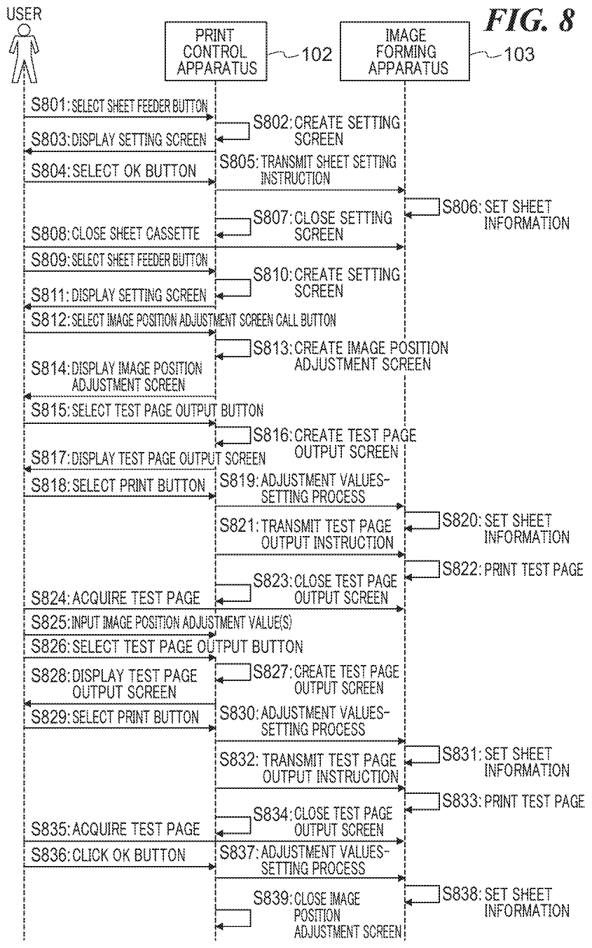

FIG. 8 is a sequence diagram useful in explaining an adjustment values-setting process performed by the sheet management system 100 in FIG. 1.

Referring to FIG. 8, when the user selects the sheet feeder button 503 associated with the sheet cassette 1 on the top screen 500 (step S801), the controller 300 of the print control apparatus 102 acquires the sheet setting management table 401 and the sheet feeder management table 402. Then, the controller 300 controls the UI control module 313 to create a setting screen 600 for setting the sheet cassette 1 based on the acquired sheet setting management table 401 and sheet feeder management table 402 (step S802). Then, the controller 300 controls the UI control module 313 to display the setting screen 600 on the display device 111 (step S803).

When the user selects the OK button 602 in the sheet list display area 601 on the setting screen 600 in a state in which certain sheet information is selected (step S804), the controller 300 causes the sheet management module 314 to produce a sheet setting instruction. This sheet setting instruction is for setting the sheet information selected in the sheet list display area 601 as sheet information of the sheet cassette 1. Then, the controller 300 controls the network control module 316 to transmit the sheet setting instruction to the image forming apparatus 103 via the control cable 108 (step S805). Upon receipt of the sheet setting instruction, the controller 200 of the image forming apparatus 103 sets sheet information designated by the sheet setting instruction for a sheet feeder designated by the sheet setting instruction, more specifically, the sheet cassette 1 (step S806). On the other hand, the controller 300 of the print control apparatus 102 controls the UI control module 313 to close the setting screen 600 (step S807) and display the top screen 500 on the display device 111.

Then, the user opens the sheet cassette 1 of the image forming apparatus 103, sets a sheet bundle in the sheet cassette 1, and closes the sheet cassette 1 (step S808). Next, when the user selects the sheet feeder button 503 associated with the sheet cassette 1 on the top screen 500 (step S809), the controller 300 controls the UI control module 313 to create a setting screen 600 for setting the sheet cassette 1 (step S810).

Then, the controller 300 controls the UI control module 313 to display the setting screen 600 on the display device 111 (step S811). When the user selects one of the buttons of the adjustment screen call button group 604, e.g. the image position adjustment screen call button 605, on the setting screen 600 (step S812), the controller 300 acquires the adjustment values for the image position included in the sheet information set for the sheet cassette 1. The adjustment values for the image position refer to upper-end shift amounts and left-end shift amounts on the front side and reverse side of sheets. Then, the controller 300 executes the input range update process described hereinafter with reference to FIG. 9B to thereby determine allowable adjustment ranges to be displayed in the input ranges 706, 710, 719, and 720. Then, the controller 300 controls the UI control module 313 to create an image position adjustment screen 700 based on the determined allowable adjustment ranges (step S813). Then, the controller 300 displays the image position adjustment screen 700 on the display device 111 (step S814). For example, in a case where all the acquired adjustment values for the image position are “0” which are their initial values, “−10 mm to +10.0 mm”, which indicate the allowable adjustment ranges for the initial values, are displayed in the input ranges 706, 710, 719, and 720.

When the user selects the test page output button 701 on the image position adjustment screen 700 (step S815), the controller 300 controls the UI control module 313 to create a test page output screen 717 with the sheet cassette 1 set as a sheet feeding location (step S816). Then, the controller 300 controls the UI control module 313 to display the test page output screen 717 on the display device 111 (step S817).

When the user selects the print button 718 on the test page output screen 717 in a state where the number of copies to be printed is input by the user (step S818), the controller 300 executes an adjustment values-setting process described hereinafter with reference to FIG. 9A (step S819). In the following description, it is assumed, by way of example, that when the user selects the test page output button 701 in the step S815, “0” has been input to each of the upper-end shift amount-inputting field 703, the left-end shift amount-inputting field 707, the upper-end shift amount-inputting field 712, and the left-end shift amount-inputting field 713.

FIG. 9A is a flowchart of the adjustment values-setting process performed by the print control apparatus 102 in FIG. 1.

Referring to FIG. 9A, the controller 300 controls the sheet management module 314 to acquire sheet information selected in the sheet list display area 601 from the sheet setting management table 401 (step S901). Then, the controller 300 edits the upper-end shift amount (on the front side) of the sheet information acquired in the step S901 (step S902). More specifically, the controller 300 adds “0”, which is the adjustment value input to the upper-end shift amount-inputting field 703, to the upper-end shift amount (on the front side) of the above-mentioned sheet information. Then, the controller 300 edits the left-end shift amount (on the front side) of the above-mentioned sheet information (step S903). More specifically, the controller 300 adds “0”, which is the adjustment value input to the left-end shift amount-inputting field 707, to the left-end shift amount (on the front side) of the above-mentioned sheet information. Then, the controller 300 edits the upper-end shift amount (on the reverse side) of the above-mentioned sheet information (step S904). More specifically, the controller 300 adds “0”, which is the adjustment value input to the upper-end shift amount-inputting field 712, to the upper-end shift amount (on the reverse side) of the above-mentioned sheet information. Then, the controller 300 edits the left-end shift amount (on the reverse side) of the above-mentioned sheet information (step S905). More specifically, the controller 300 adds “0”, which is the adjustment value input to the left-end shift amount-inputting field 713, to the left-end shift amount (on the reverse side) of the above-mentioned sheet information. Then, the controller 300 transmits a sheet setting instruction for setting the sheet information edited in the steps S902 to S905 as sheet information of the sheet cassette 1 to the image forming apparatus 103 (step S906). The image forming apparatus 103 sets the sheet information edited in the steps S902 to S905 as the sheet information of the sheet cassette 1 (e.g. step S820 in FIG. 8).

Then, the controller 300 writes the sheet information edited in the steps S902 to S905 in the sheet setting management table 401. Then, the controller 300 performs the input range update process, described hereinafter with reference to FIG. 9B (step S907). In the step S907, the controller 300 determines allowable adjustment ranges to be displayed in the input ranges 706, 710, 719, and 720 e.g. as −10 mm-+10.0 mm, based on the values input to the image position adjustment screen 700. Then, the controller 300 updates the image position adjustment screen 700 (step S908). More specifically, the controller 300 displays the determined allowable adjustment ranges in the input ranges 706, 710, 719, and 720 on the image position adjustment screen 700. After that, the controller 300 terminates the process in FIG. 9A.

FIG. 9B is a flowchart of the input range update process performed by the print control apparatus 102 in FIG. 1. In the present embodiment, it is assumed that a default value of the upper limit value of the allowable adjustment range is “10.0 mm”, and a default value of the lower limit value of the allowable adjustment range is “−10.0 mm”.

Referring to FIG. 9B, the controller 300 determines the upper limit value of the allowable adjustment range displayed in the input range 706 (step S911). More specifically, the controller 300 determines “10.0”, which is obtained by subtracting “0”, which is the adjustment value input to the upper-end shift amount-inputting field 703, from “10.0”, which is the default value of the upper limit value of the allowable adjustment range, as the upper limit value of the allowable adjustment range displayed in the input range 706. Then, the controller 300 determines the lower limit value of the allowable adjustment range displayed in the input range 706 (step S912). More specifically, the controller 300 determines “−10.0”, which is obtained by subtracting “0”, which is the adjustment value input to the left-end shift amount-inputting field 707, from “−10.0”, which is the default value of the lower limit value of the allowable adjustment range, as the lower limit value of the allowable adjustment range displayed in the input range 706. Then, similar to the steps S911 and S912, the controller 300 determines the upper limit value and the lower limit value of the allowable adjustment range displayed in the input range 710 (steps S913 and S914). Then, similar to the steps S911 and S912, the controller 300 determines the upper limit value and the lower limit value of the allowable adjustment range displayed in the input range 719 (steps S915 and S916). Then, similar to the steps S911 and S912, the controller 300 determines the upper limit value and the lower limit value of the allowable adjustment range displayed in the input range 720 (steps S917 and S918), followed by terminating the process in FIG. 9B.

Referring again to FIG. 8, the controller 300 of the print control apparatus 102 transmits a test page output instruction to the image forming apparatus 103 (step S821). The test page output instruction includes e.g. information indicating that the sheet feeding location is the sheet cassette 1, information indicating the number of copies to be printed, and a sheet ID indicating the sheet cassette 1. The controller 200 of the image forming apparatus 103 prints a test page based on the received test page output instruction (step S822). In the step S822, the controller 200 prints a test page based on print data of the test page stored in advance in the external storage device 209 or the like. The controller 200 controls the job control module 217 to deliver image signals indicative of the above-mentioned print data to the print engine 213 to thereby cause the print engine 213 to print the test page.

On the other hand, the controller 300 of the print control apparatus 102 controls the UI control module 313 to close the test page output screen 717 (step S823). Further, the controller 300 displays the image position adjustment screen 700 on the display device 111 in a state in which the values in the upper-end shift amount-inputting field 703,—the left-end shift amount-inputting field 707, the upper-end shift amount-inputting field 712, and the left-end shift amount-inputting field 713 are reset to 0, which is their initial values.

The user acquires the test page output from the image forming apparatus 103 (step S824), and inputs adjustment values for the image position measured from the acquired test page, to the image position adjustment screen 700 (step S825). When the user selects the test page output button 701 in a state in which “0.7” is input to the upper-end shift amount-inputting field 703 of the front side shift amount-setting area 702, and “−1.3” is input to the left-end shift amount-inputting field 707 (step S826), the controller 300 performs the same processing as in the steps S816 and S817. More specifically, the controller 300 controls the UI control module 313 to create a test page output screen 717 with the sheet cassette 1 set as a sheet feeding location (step S827), and display the test page output screen 717 on the display device 111 (step S828).

When the user selects the print button 718 on the test page output screen 717 in a state in which the number of copies to be printed is input by the user (step S829), the controller 300 executes the adjustment values-setting process described above with reference to FIG. 9A (step S830). In the step S830, for example, the controller 300 determines “9.3”, which is obtained by subtracting “0.7”, which is the adjustment value input to the upper-end shift amount-inputting field 703, from “10.0”, which is the default value of the upper limit value of the allowable adjustment range, as the upper limit value of the allowable adjustment range displayed in the input range 706. Further, the controller 300 determines “−10.7”, which is obtained by subtracting “0.7”, which is the adjustment value input to the upper-end shift amount-inputting field 703, from “−10.0”, which is the default value of the lower limit value of the allowable adjustment range, as the lower limit value of the allowable adjustment range displayed in the input range 706. Similarly, the controller 300 determines “11.3”, which is obtained by subtracting “−1.3”, which is the adjustment value input to the left-end shift amount-inputting field 707, from “10.0”, which is the default value of the upper limit value of the allowable adjustment range, as the upper limit value of the allowable adjustment range displayed in the input range 710. Further, the controller 300 determines “−8.7”, which is obtained by subtracting “−1.3”, which is the adjustment value input to the left-end shift amount-inputting field 707, from “−10.0”, which is the default value of the lower limit value of the allowable adjustment range, as the lower limit value of the allowable adjustment range displayed in the input range 710. The allowable adjustment ranges determined as above are displayed on the image position adjustment screen 700 (see e.g. the input ranges 706 and 710).

The controller 200 of the image forming apparatus 103 sets the sheet information received from the print control apparatus 102 as sheet information of the sheet cassette 1 (step S831). Then, the controller 300 of the print control apparatus 102 transmits a test page output instruction to the image forming apparatus 103 (step S832). The controller 200 of the image forming apparatus 103 prints a test page based on the received test page output instruction (step S833). The controller 300 of the print control apparatus 102 controls the UI control module 313 to close the test page output screen 717 (step S834). Further, the controller 300 displays the image position adjustment screen 700 on the display device 111 in the state in which the values in the upper-end shift amount-inputting field 703, the left-end shift amount-inputting field 707, the upper-end shift amount-inputting field 712, and the left-end shift amount-inputting field 713 are reset to 0, which is their initial values.

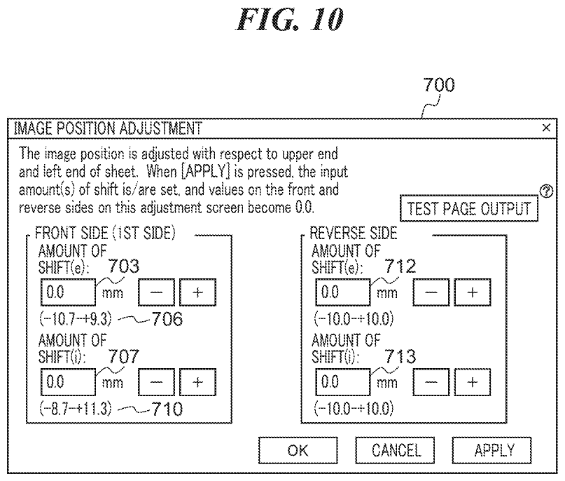

The user acquires the test page output from the image forming apparatus 103 (step S835). Here, for example, in a case where it is necessary to further adjust the image position on the acquired test page, the user inputs adjustment values for the image position measured from the acquired test page to the image position adjustment screen 700. At this time, the image position adjustment screen 700 displays the allowable adjustment ranges of the adjustment values for the image position using increasing and decreasing amounts relative to the adjustment values set in the step S831, as shown in the input ranges 706 and 710 in FIG. 10. For this reason, before instructing the image forming apparatus 103 to print the test page, the user can easily determine whether or not the adjustment values being input to the image position adjustment screen 700 exceed the allowable adjustment ranges.

On the other hand, in a case where it is unnecessary to further adjust the image position on the acquired test page, when the user selects the OK button 714 on the image position adjustment screen 700 (step S836), the controller 300 performs the adjustment values-setting process described above with reference to FIG. 9A (step S837). The controller 200 of the image forming apparatus 103 sets the sheet information received from the print control apparatus 102 as sheet information of the sheet cassette 1 (step S838). Then, the controller 300 of the print control apparatus 102 controls the UI control module 313 to close the image position adjustment screen 700 (step S839), followed by terminating the present process.

According to the above-described embodiment, the image position adjustment screen 700 displays the allowable adjustment ranges of the adjustment values for the image position using increasing and decreasing amounts relative to the currently set adjustment values. This makes it possible for the user to easily grasp whether or not the adjustment values for the image position can be adjusted to desired values.

Further, in the above-described embodiment, when the allowable adjustment ranges of the adjustment values for the image position are displayed on the image position adjustment screen 700 using increasing and decreasing amounts relative to the currently set adjustment values, the values in the upper-end shift amount-inputting field 703, the left-end shift amount-inputting field 707, the upper-end shift amount-inputting field 712, and the left-end shift amount-inputting field 713 are reset to their initial values. This makes it possible to delete unnecessary information from the image position adjustment screen 700. As a consequence, it is possible to avoid confusion of the user who checked the image position adjustment screen 700 in order to determine whether or not the adjustment values for the image position can be adjusted to desired values.

Furthermore, in the above-described embodiment, the image position is adjusted based on values obtained by accumulation of values input to the image position adjustment screen 700 to adjustment values for the image position set in the past. With this, in a configuration in which values obtained by accumulation of values input to the image position adjustment screen 700 to adjustment values for the image position set in the past are set as the adjustment values for the image position, it is possible to enable the user to grasp whether or not the adjustment values for the image position can be adjusted to desired values.

Although the description has been given of the present invention based on the above-described embodiment, the present invention is not limited to the above-described embodiment. For example, the adjustment values-setting process may be performed in a case where the user selects the apply button 716 on the image position adjustment screen 700, or in a case where the user selects the image position adjustment screen call button 605 on the setting screen 600.

Although in the above-described embodiment, the description has been given of the case where the present invention is applied to the print control apparatus 102 as an image position setting apparatus, the present invention is not limited to the print control apparatus 102. For example, the present invention may be applied to the client PC 101 as a communication apparatus which displays the image position adjustment screen 700 on the display device 114. Further, the present invention may be applied to the image forming apparatus 103 which displays the image position adjustment screen 700 on the console section 105.

Further, although in the above-described embodiment, the description has been given of the case where the adjustment values for the image position are set, the type of adjustment values is not limited to the adjustment values for the image position, but the adjustment values may be values of other types of adjustment whose allowable adjustment range is defined by predetermined upper and lower limit values, such as adjustment of a secondary transfer voltage, a curl correction amount, gloss/black grade adjustment, trailing end white void correction, saddle-stitching setting, and the quantity of air supplied by a sheet fan.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-067706, filed Mar. 29, 2019, which is hereby incorporated by reference herein in its entirety.

What is claimed is:

1. An image position setting apparatus that sets an image position adjustment value for adjusting a position on a sheet where an image is formed, comprising:
at least one memory that stores a set of instructions; and
at least one processor that executes the instructions, the instructions, when executed, causing the image position setting apparatus to perform operations comprising:
setting the image position adjustment value; and
performing display control of an input screen for inputting the image position adjustment value,
wherein the display control includes displaying an allowable adjustment range of the image position adjustment value on the input screen, using increasing and decreasing amounts relative to a currently set image position adjustment value.

2. The image position setting apparatus according to claim 1, wherein the display control includes resetting a value in an input field for the image position adjustment value on the input screen to an initial value, when the allowable adjustment range of the image position adjustment value is displayed on the input screen using the increasing and decreasing amounts relative to the currently set image position adjustment values.

3. The image position setting apparatus according to claim 1, wherein the operations further comprising performing control for adjusting the position on the sheet where an image is formed, based on a value obtained by accumulating a value input to the input screen to the image position adjustment value set in the past.

4. The image position setting apparatus according to claim 1, wherein the image position setting apparatus is a communication apparatus that transmits the image position adjustment value to an image forming apparatus that forms an image on the sheet.

5. The image position setting apparatus according to claim 1, wherein the image position setting apparatus is an image forming apparatus that forms an image on the sheet.

6. A method of controlling an image position setting apparatus that sets an image position adjustment value for adjusting a position on a sheet where an image is formed, comprising:
setting the image position adjustment value; and
performing display control of an input screen for inputting the image position adjustment value,
wherein the display control includes displaying an allowable adjustment range of the image position adjustment value on the input screen using increasing and decreasing amounts relative to a currently set image position adjustment value.

7. The method according to claim 6, wherein the display control includes resetting a value in an input field for the image position adjustment value on the input screen to an initial value, when the allowable adjustment range of the image position adjustment value is displayed on the input screen using the increasing and decreasing amounts relative to the currently set image position adjustment values.

8. The method according to claim 6, wherein the operations further comprising performing control for adjusting the position on the sheet where an image is formed, based on a value obtained by accumulating a value input to the input screen to the image position adjustment value set in the past.

9. A non-transitory computer-readable storage medium storing a computer-executable program for executing a method of controlling an image position setting apparatus that sets an image position adjustment value for adjusting a position on a sheet where an image is formed,
wherein the method comprises:
setting the image position adjustment value; and
performing display control of an input screen for inputting the image position adjustment value,
wherein the display control includes displaying an allowable adjustment range of the image position adjustment value on the input screen using increasing and decreasing amounts relative to a currently set image position adjustment value.

10. The non-transitory computer-readable storage medium according to claim 9, wherein the display control includes resetting a value in an input field for the image position adjustment value on the input screen to an initial value, when the allowable adjustment range of the image position adjustment value is displayed on the input screen using the increasing and decreasing amounts relative to the currently set image position adjustment values.

11. The non-transitory computer-readable storage medium according to claim 9, wherein the operations further comprising performing control for adjusting the position on the sheet where an image is formed, based on a value obtained by accumulating a value input to the input screen to the image position adjustment value set in the past.
